(19) United States
(12) Patent Application Publication
(10) Pub. No.: US 2023/0155500 A1
(43) Pub. Date: May 18, 2023

(54) LOAD DEPENDENT FREQUENCY SHIFT BOOST CONVERTER

(71) Applicant: Panasonic Automotive Systems Company of America, Division of Panasonic Corporation of North America, Peachtree City, GA (US)

(72) Inventors: ROBERT BARTON BALDWIN, JR., NEWNAN, GA (US); ERIC SHUFRO, PEACHTREE CITY, GA (US)

(21) Appl. No.: 17/986,937

(22) Filed: Nov. 15, 2022

Related U.S. Application Data
(60) Provisional application No. 63/279,257, filed on Nov. 15, 2021.

(51) Int. Cl. H02M 3/157; H02M 1/00; H02M 1/08

(52) U.S. Cl. CPC H02M 3/157; H02M 1/0009; H02M 1/08

(57) ABSTRACT

Examples of the disclosure relate to example devices and methods for delivering electrical power. An example electrical power delivery device includes a boost converter circuitry configured to convert a voltage received at an input to a higher voltage at an output. The electrical power delivery device also includes a driver to control the boost converter circuitry by providing a switching signal to the boost converter circuitry at a specified duty cycle and switching frequency. The output voltage of the boost converter circuitry is controlled by adjusting the duty cycle. The electrical power delivery device also includes a current sensor to detect a current at the output of the boost converter circuitry, and a frequency controller to adjust the switching frequency provided by the driver based on the current detected by the current sensor.

### CROSS-REFERENCE TO RELATED APPLICATIONS

This application claims the benefit of U.S. Provisional Application No. 63/279,257, filed on Nov. 15, 2021, which the disclosure of which is hereby incorporated by reference in its entirety for all purposes.

### FIELD OF THE INVENTION

The present disclosure generally relates to techniques for implementing a boost converter. More specifically, the present disclosure relates to implementing a boost converter with a frequency shift.

### BACKGROUND

This section is intended to introduce the reader to various aspects of art, which may be related to various aspects of the present disclosure, which are described and/or claimed below. This discussion is believed to be helpful in providing the reader with background information to facilitate a better understanding of the various aspects of the present disclosure. Accordingly, it can be understood that these statements are to be read in this light, and not as admissions of prior art.

A voltage converter is a power converter that changes voltage of an electrical power source. One type of voltage converter is referred to as switched mode power supply. Switch mode power supplies can be used to transfer power from a direct current (DC) source to a DC load while converting the voltage level upward or downward. One type of switch mode power supply is often referred to as a boost converter. Boost converters are configured to convert a lower voltage provided by a power source to a higher voltage provided at the load.

### SUMMARY

The present disclosure generally relates to techniques for implementing a boost converter. An example of an electrical power delivery device in accordance with embodiments includes boost converter circuitry configured to convert a voltage received at an input to a higher output voltage at an output of the boost converter circuitry. The device also includes a driver to control the boost converter circuitry by providing a switching signal to the boost converter circuitry at a specified duty cycle and switching frequency. The output voltage is controlled by adjusting the duty cycle. The device also includes a current sensor to detect a current at the output of the boost converter circuitry, and a frequency controller to adjust the switching frequency provided by the driver based on the current detected by the current sensor.

The present techniques further include a method of operation for a boost controller. The method includes driving a boost converter using a switching signal exhibiting a specified duty cycle and switching frequency. The method also includes detecting current at an output of the boost converter. The method further includes adjust a switching frequency of the switching signal based on the detected current.

The present techniques also include a power supply for a vehicle. The power supply includes a boost converter circuitry configured to convert a voltage received at an input to a higher output voltage at an output of the boost converter circuitry. The power supply includes a driver to control the boost converter circuitry by providing a switching signal to the boost converter circuitry at a specified duty cycle and switching frequency, wherein the output voltage is controlled by adjusting the duty cycle. The power supply includes a current sensor to detect a current at the output of the boost converter circuitry. The power supply further includes a frequency controller to adjust the switching frequency provided by the driver based on the current detected by the current sensor.

### BRIEF DESCRIPTION OF THE DRAWINGS

The above-mentioned and other features and advantages of the present disclosure, and the manner of attaining them, may become apparent and be better understood by reference to the following description of one example of the disclosure in conjunction with the accompanying drawings, where:

FIG. 1 is a block diagram of an example frequency shift boost converter in accordance with embodiments;

FIG. 2 is a plot of switching frequency versus current for a boost converter in accordance with embodiments;

FIG. 3 is an example of a boost converter with a digital frequency controller in accordance with embodiments;

FIG. 4 is an example of a boost converter with an analog frequency controller in accordance with embodiments; and

FIG. 5 is a process flow diagram of an example method of operation for a boost converter in accordance with embodiments.

Correlating reference characters indicate correlating parts throughout the several views. The exemplifications set out herein illustrate examples of the disclosure, in one form, and such exemplifications are not to be construed as limiting in any manner the scope of the disclosure.

### DETAILED DESCRIPTION OF EXAMPLES

One or more specific examples of the present disclosure are described below. In an effort to provide a concise description of these examples, not all features of an actual implementation are described in the specification. It can be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it can be appreciated that such a development effort might be complex and time consuming, and is a routine undertaking of design, fabrication, and manufacture for those of ordinary skill having the benefit of this disclosure.

The present disclosure describes techniques for implementing a boost converter. A boost converter is a type of step-up switch mode power supply that converts a lower voltage provided by a power source to a higher voltage provided at the load. Boost converters are used frequently in automotive applications to step up a 12 volt (V) battery voltage to a higher voltage such as 24V or 48V. Voltages higher than 12V are sometimes required in automotive applications such as premium audio systems or advanced lighting systems.

A boost converter, also known as a step-up converter, is a DC to DC converter that includes at least one energy storage component, such as an inductor. The inductor is coupled to a voltage source through a switch that bypasses the load and cycles between an off state and an on state to induce current in the inductor. This results in an increased voltage at the load compared to the voltage source. A typical boost converter may operate at a fixed frequency, and the output voltage may be regulated by altering the duty cycle of the pulse-width modulation (PWM) waveform that controls the switch, which may be a Metal Oxide Semiconductor Field Effect Transistor (MOSFET) for example. The inductor value selected for a boost converter is typically determined based on the maximum expected output current and the desired switching frequency.

Due to the electrical response of the inductor, the pulsed waveform of the switching signal will induce a ripple current through the inductor, the load, and other components of the boost converter. The ripple current can have negative effects on the circuit, such as increased electromagnetic interference (EMI). The magnitude of the ripple current can be reduced by increasing the size of the inductor. However, if the inductor is too large, the boost converter may not be able to generate the desired voltage during times of high current load. For this reason, typical designs aim to keep the ripple current at reasonable levels between 20 to 40 percent at peak load conditions, for example.

In some applications, the boost converter may experience highly a variable load. In such cases, the boost converter may be operating at a much lower current output than it has been designed to handle. For example, a typical boost converter designed to power an automotive audio amplifier may be designed to handle a 5 Amp output current, but might operate in the 1-2 Amp range 90% of the time. During those times, the ripple current may be much higher than it needs to be for the current operating conditions. Accordingly, typical boost converters are inefficient at lighter load conditions.

To overcome these challenges, dual stage boost converters have been developed. A dual stage boost converter uses two power stages in parallel, each power stage having its own inductor and switch. Proper coordination of the two power stages can have the effect of meeting the power demands while also maintaining a low ripple current for a wider range operating conditions. However, such designs are more complicated and expensive due the increased part count.

Additionally, some boost converts may operate at a variable frequency with a fixed ON time. The ON time refers to the portion of each switch period in which the main switch is turned on to allow current to flow through the inductor. In such boost converters, the duty cycle can be effectively increased to support higher load currents by increasing the switching frequency for higher current outputs. However, this technique is not usually employed in audio amplifiers, because increasing the switching frequency for higher current outputs tends to introduce noise that can be heard in audio circuits.

Some boost converters are resonant or quasi-resonant and use a resonant tank circuit consisting of inductors and capacitors to increase efficiency by timing the switching so that the switch turns on at minimum current. This type of power supply typically has a fixed switching duty cycle and regulates the output voltage by shifting the operating frequency. However, resonant boost converters are more expensive because additional inductors and capacitors are required.

The present disclosure describes a boost converter with increased efficiency and reduced ripple current over a wide range of load conditions. The boost converter in accordance with embodiments regulates the output voltage by altering the duty cycle of the PWM switching signal. Additionally, the output current to the load is monitored and the switching frequency of the boost converter is adjusted in response to the output current. For lower load currents, the switching frequency is increased, and for higher load currents the switching frequency is decreased. Altering the switching frequency in this way can increase the efficiency of the boost converter across a range of dynamic load conditions. For example, reducing the switching frequency at times of lower current load also reduces the ripple current. In some embodiments, the switching frequency may be selected to maintain a consistent ripple current across the operating range of the boost converter, which also represents a reduction in MOSFET transistor peak current. Another benefit is that MOSFET transistors used in switching power supplies dissipate less heat when switching at lower frequencies, therefore switching losses may decrease as load current increases. This enables the boost converter to have higher efficiency at low output current levels compared to typical boost converters.

The disclosed techniques increase the efficiency of a boost converter when powering highly dynamic loads such as automotive audio power amplifiers. A boost converter in accordance with embodiments also has reduced cost because the efficiency increase can allow less costly components to be used and also allows for a single phase boost converter to be used where a dual phase boost might be typically used. Embodiments of the present techniques can also be used with multi-phase boost converters to further increase efficiency and reduce EMI. A boost converter in accordance with embodiments may have significantly lower EMI emissions than a typical boost converter due to lower inductor ripple current and lower MOSFET peak current at lighter load conditions. In addition, lower radiated EMI may enable the use of a less expensive mechanical housing in a product using the techniques described herein.

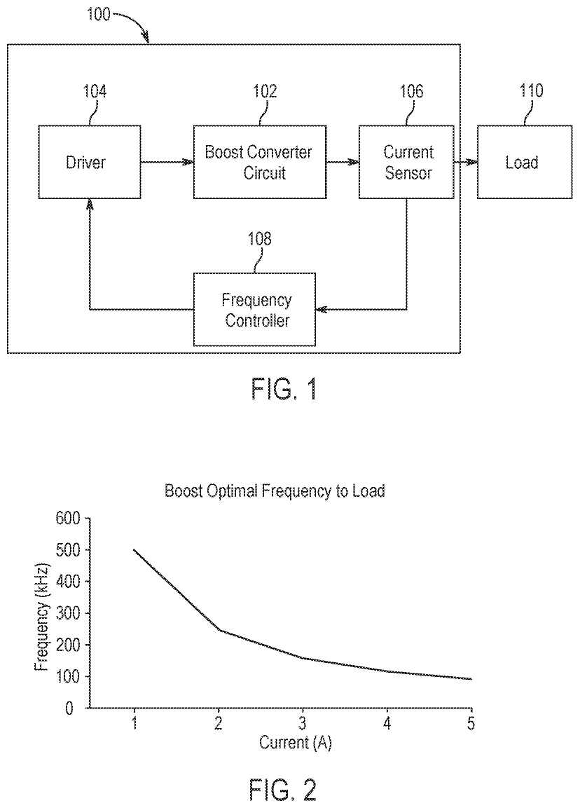

FIG. 1 is a block diagram of an example frequency shift boost converter in accordance with embodiments. The boost converter 100 may be deployed within a vehicle to provide DC power to one or more vehicle subsystems, such as an audio subsystem, touch screen display, interior lighting subsystem, motorized subsystems such as window or seating controls, and many others.

In embodiments, the boost converter 100 includes a boost converter circuit 102, a driver 104, a current sensor 106, and a frequency controller 108. The boost converter 100 is coupled to a load 110, which represents the various components configured to draw electrical power from the boost converter 100. The boost converter circuit 102 may be any suitable type of DC-to-DC switch mode power supply that steps up the voltage level from the input side to the load side. The boost converter circuit 102 may include the various circuit elements used for energy storage, switching, rectifying, and filtering, such as inductors, transistors, diodes, capacitors, and others.

The boost converter circuit 102 is controlled by the driver 104, which generates the switching signals that are used to control the operation of the boost converter circuit 102. The driver can 104 be implemented in any suitable configuration of electrical hardware, including an integrated circuit chip and others. The driver 104 may be a PWM driver that generates a PWM waveform. The duty cycle of the switching signal waveform can be controlled through the driver 104 to determine the output voltage of the boost converter 100. In some embodiments, boost converter 100 is configured to maintain a constant voltage that is suitable for the specific components to be powered by the boost converter 100. However, the current may be expected to vary depending on the specific load conditions present at any time. For example, the current output may vary depending on the configuration of the components drawing power from the boost converter 100, such as the volume level of the audio subsystem, the activation or brightness level of lighting system, and others.

The current output by the boost converter 100 and delivered to the load 110 may be measured by any suitable current sensor 106. A signal indicating the current detected by the current sensor 106 is detected by the frequency controller 108. The frequency controller 108 then delivers a signal to the driver 104 that controls the frequency of the switching signal based on the detected current level. In some embodiments, the switching frequency specified by the frequency controller 108 is a frequency that will result in a target ripple current ratio at the inductor of the boost converter circuit 102. In this way, the ripple current ratio at the inductor can remain constant as the current output changes due to changing load conditions. The duty cycle of the switching signal is controlled separately and is not effected by the change in the switching frequency.

The ripple current ratio is defined as the peak-to-peak variation in the current, ΔI_{L}, divided by the average DC current. For example, if the average output current is 10 Amps and the current varies from 8.5 Amps to 11 Amps, the ripple current is 3 Amps and the ripple current ratio is 3 Amps divided by 10 Amps, or 0.3 (30 percent).

In some embodiments, the switching frequency can be determined in two parts. First the inductor ripple current, ΔI_{L}, is calculated based on output current, using the following formula:

$$Δ {I}_{L} = ( ripple\_current \_ratio ) \times {I}_{O U T} \times \frac{{V}_{OUT}}{{V}_{IN}} \qquad Eq . 1$$

where the ripple_current_ratio is the selected ripple current ratio, I_{OUT} is the measured output current, V_{OUT} is the target output voltage, and V_{IN} is the voltage of the voltage source. Next, the desired switching frequency, f_{sw}, is calculated based on the ripple current using the following formula:

$${f}_{SW} = \frac{{V}_{IN} \times ( {V}_{OUT} - {V}_{IN} )}{Δ {I}_{L} \times L \times {V}_{OUT}} \qquad Eq . 2$$

where ΔI_{L}, is the ripple current calculated based on the measured current and L is the inductance of the inductor.

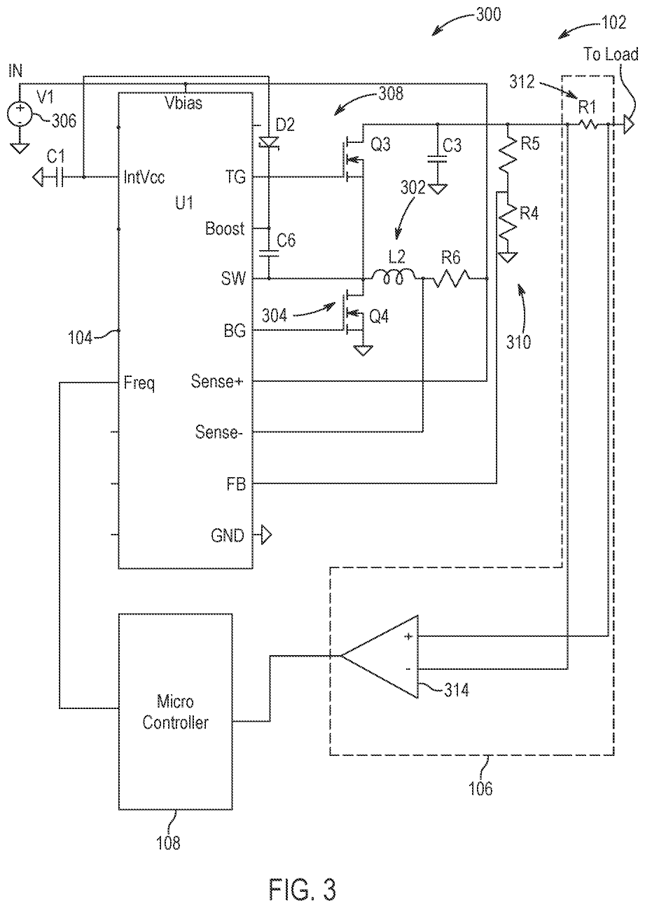

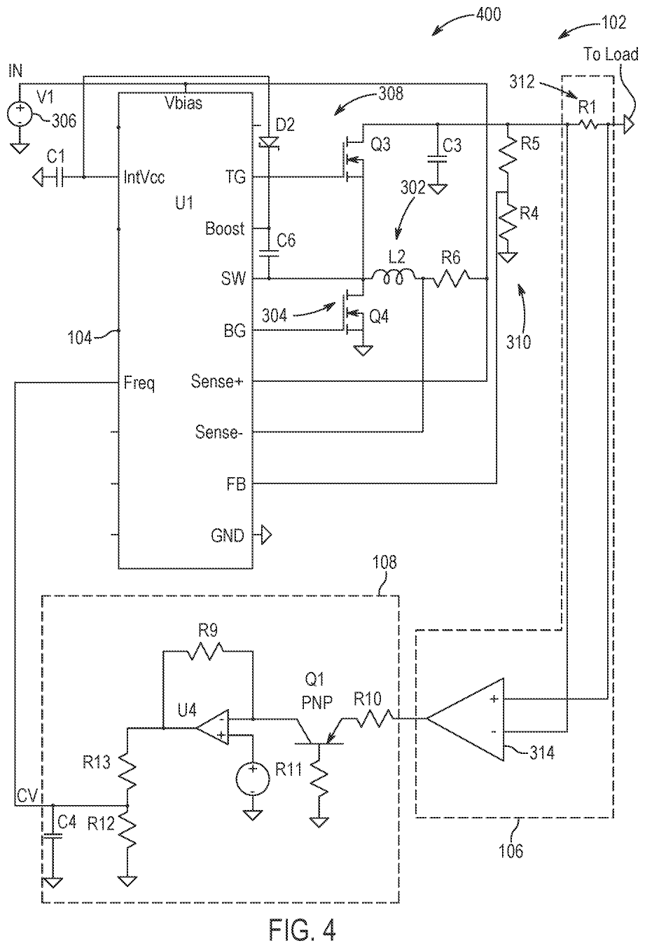

The frequency controller 108 may be implemented in any suitable configuration of electrical hardware, such as a digital microcontroller, a configuration of analog circuit elements, or a combination thereof. The frequency of the switching signal can be adjusted over a continuous range of frequencies or in discrete frequency steps. In digital implementations, the frequency controller 108 can determine the correct frequency by calculating the switching frequency using, for example, the above formulas, a formula derived from the above formulas, or by performing a lookup in a table of frequency values using the detected current as the input to the lookup table. More detailed examples of boost converters in accordance with embodiments are described below in relation to FIGS. 3 and 4.

FIG. 2 is a plot of switching frequency versus current for a boost converter in accordance with embodiments. The switching frequency at each current output level is the frequency that will maintain a constant ripple current ratio over the range of output currents. The specific frequencies shown in FIG. 2 are applicable for maintaining a 0.3 ripple current factor at the inductor of an example boost converter with a 13 V input voltage, a 24 V output voltage, and a 22 micro-Henry (μH) inductor. It will be appreciated the specific frequency curve applicable for a given boost converter may vary depending on the specific design details of the boost converter, such as the desired ripple current factor, the input voltage, the output voltage, and the inductor size, and other factors.

FIG. 3 is an example of a boost converter with a digital frequency controller in accordance with embodiments. The example boost converter 300 includes the boost converter circuit 102, the driver 104, the current sensor 106, and the frequency controller 108. The boost converter circuit 102 in this example includes an inductor 302 and a main switch 304, which controls the current through the inductor 302. The input of the inductor 302 is coupled to a voltage source 306. The output of the inductor 302 is coupled to the load through a synchronous rectifier 308 which is formed by another switch. During operation of the boost converter 300, the voltage at the input of the inductor 302 is converted to a higher voltage at the output of the inductor 302 through properly timed switching of the main switch 304, while rectification of the output voltage is achieved through properly timed switching of the synchronous rectifier 308. The switching of the main switch 304 and the synchronous rectifier 308 are controller by the driver 104.

The boost converter circuit 102 may also include a voltage divider 310 coupled at the output of the synchronous rectifier 308 in parallel with the load. The voltage divider 310 generates a voltage feedback signal that is delivered to a feedback port (FB) of the driver 104. The driver 104 can use the feedback signal to adjust the output voltage, for example, by altering the duty cycle of the switching signal delivered to the main switch 304.

In some embodiments, the driver 104 can also receive a current feedback signal from the boost converter circuit through a pair of current sense comparator ports, sense+ and sense−, coupled to current sense resistor, R6, disposed at the input of the inductor 302. The current feedback signal can be used by the driver 104 to limit the current through the inductor 302. For example, if the current sensed at the input of the inductor 302 increases above a threshold current level, the driver 104 can respond by reducing the target DC voltage output of the boost converter 300.

It will be appreciated that the driver 104 and boost converter circuit 102 are examples of circuitry that may be used in accordance with embodiments. In an actual implementation, the driver 104 and boost converter circuit 102 may provide additional functions and features not described herein. Additionally, various features described in relation to FIG. 3 may be eliminated or altered. For example, the boost converter circuit 102 may include a diode in place of the synchronous rectifier 308, in which case the switching signal provided by the driver 104 to the synchronous rectifier 308 may be unused or eliminated.

The boost converter circuit 102 includes or is coupled to a current sensor 106 to sense the current output by the boost converter 300. In this example, the current sensor 106 includes a current sense resistor 312 coupled in series with the load. The voltage at each end of the current sense resistor 312 is coupled to an amplifier 314, which detects the voltage difference across the current sense resistor 312 and converts this difference to current sense signal that represents the current output by the boost converter 300. The current sense signal is input to the frequency controller 108, which may include an analog-to-digital converter that converts the current sense signal to a digital value for further processing.

The detected current level indicated by the current sense signal is used by the frequency controller 108 to determine the target switching frequency of the boost converter, i.e., the frequency of the switching signal to be used to drive the main switch 304. The frequency controller 108 may be any suitable integrated circuit such as a microcontroller, Field Programmable Gate Array (FPGA), and others. The frequency controller 108 outputs a frequency selection signal to the driver 104. Characteristics of the frequency selection signal will vary depending on the configuration of the driver 104. For example, the frequency selection signal may be a voltage level that the driver 104 interprets as corresponding with a selected frequency. The frequency selection signal may also be a digital value indicative of the selected frequency.

The frequency controller 108 and current sense circuit 106 shown in FIG. 3 is one example of a digital implementation of a frequency control device in accordance with embodiments. In an actual implementation, various features of the frequency controller 108 and/or current sense circuit 106 may vary from what is shown in FIG. 3. For example, in some embodiments, the voltage signals from the current sense resistor 312 may be coupled directly to ports of the frequency controller 108, in which case the current sense amplifier 314 may be eliminated.

FIG. 4 is an example of a boost converter with an analog frequency controller in accordance with embodiments. The example boost converter 400 of FIG. 4 is similar to the boost converter 300 of FIG. 3 and includes the boost converter circuit 102, driver 104, and current sensor 106 described in relation to FIG. 3. However, in this embodiments, the frequency controller 108 is implemented as an analog control circuit.

As shown in FIG. 4, the analog frequency controller 108 receives the current sense signal from the current sense amplifier 314. The frequency controller 108 in this example is configured as an antilog amplifier. The antilog amplifier is an operational amplifier circuit configured so that the output voltage is proportional to the exponential value of the input, which is current sense signal from the current sense amplifier 314 in this case. The antilog amplifier can be configured to perform an analog computation in that is receives the voltage signal from the current sensor 314 and generates a corresponding frequency selection signal applicable for the specific driver 104.

The table below shows an example frequency selection signal generated by antilog amplifier shown in FIG. 4. It will be appreciated that the table shows only selected data points and that the actual data curve will be continuous. It will also be appreciated that the results shown in Table 1 are one example of results that may be obtained depending on the design of the antilog amplifier, which may be adjusted according to the target frequency applicable for a specific detected current level. As with the boost converter described in relation to FIG. 3, the target frequency may be the frequency that maintains a consistent ripple current ratio over the range of possible boost converter output currents.

TABLE 1
Example relationships between the detected output current,
frequency selection signal, and target switching frequency.

| Detected Output | Target Switching | Frequency Selection |
|---|---|---|
| Current | Frequency | Signal |
| 1 Amp | 500 kHz | 1.4 Volt |
| 2 Amp | 250 kHz | 0.8 Volt |
| 3 Amp | 165 kHz | 0.6 Volt |
| 4 Amp | 125 kHz | 0.54 Volt |
| 5 Amp | 100 kHz | 0.5 Volt |

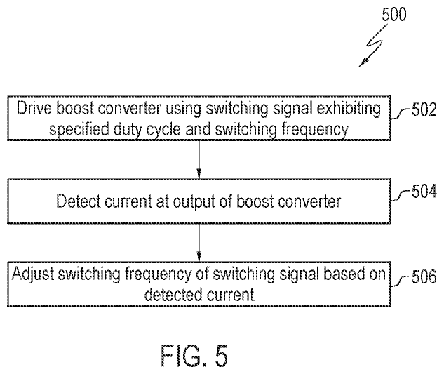

FIG. 5 is a process flow diagram of an example method of operation for a boost converter in accordance with embodiments. Each of the functions of this method 500 can be performed in an ongoing basis to form a pipeline of continuously updating information and actions. The method 500 may be performed by any of the boost converters described herein. The method may begin at block 502.

At block 502, the boost converter is driven using a switching signal exhibiting a specified duty cycle and switching frequency. The duty cycle may be specified to produce a desired voltage level at the output of the boost converter. The duty cycle may also be adjusted depending on a feedback signal that indicates the voltage being output by the boost converter at any moment. At startup, the switching frequency may be selected based on an expected current load that may be expected at startup.

At block 504, the current at an output of the boost converter is detected. The current at the output is the current being delivered to a load coupled to the boost converter. The current at the output may be detected using any suitable current detection circuitry, including the circuitry described herein or others.

At block 506, the switching frequency is adjusted based on the current detected at block 504. In various examples, the switching frequency may be selected to maintain a specified current ripple ratio as the output current changes. In some examples, the boost converter may be configured to maintain a current ripple ratio of 0.2, 0.3, 0.4, or values in between.

The method 500 should not be interpreted as meaning that the blocks are necessarily performed in the order shown. Furthermore, fewer or greater actions can be included in the method 500 depending on the design considerations of a particular implementation.

While the invention may be susceptible to various modifications and alternative forms, specific embodiments have been shown by way of example. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An electrical power delivery device, comprising:
a boost converter circuitry configured to convert a voltage received at an input to a higher output voltage at an output of the boost converter circuitry;
a driver to control the boost converter circuitry by providing a switching signal to the boost converter circuitry at a specified duty cycle and switching frequency, wherein the output voltage is controlled by adjusting the duty cycle;
a current sensor to detect a current at the output of the boost converter circuitry; and
a frequency controller to adjust the switching frequency provided by the driver based on the current detected by the current sensor.

2. The electrical power delivery device of claim 1, wherein the switching frequency is adjusted to maintain a consistent ripple current ratio as the current at the output of the boost converter circuitry varies.

3. The electrical power delivery device of claim 2, wherein the consistent ripple current ratio is between 0.2 and 0.4 for all values of the output current above zero.

4. The electrical power delivery device of claim 1, wherein the frequency controller increases the switching frequency when the output current decreases, and decreases the switching frequency when the output current increases.

5. The electrical power delivery device of claim 1, wherein frequency controller is a digital frequency controller comprising an integrated circuit chip.

6. The electrical power delivery device of claim 1, wherein frequency controller is an analog frequency controller comprising an antilog amplifier.

7. The electrical power delivery device of claim 1, wherein the boost converter circuitry comprises a single phase boost converter.

8. A method of operation for a boost controller, the method comprising:
driving a boost converter using a switching signal exhibiting a specified duty cycle and switching frequency;
detecting current at an output of the boost converter; and
adjust a switching frequency of the switching signal based on the detected current.

9. The method of claim 8, wherein the switching frequency is adjusted to maintain a consistent ripple current ratio as the detected current at the output of the boost converter varies.

10. The method of claim 9, wherein the consistent ripple current ratio is between 0.2 and 0.4 for all values of the output current above zero.

11. The method of claim 8, wherein adjusting the switching frequency comprises increases the switching frequency when the detected current decreases, and decreasing the switching frequency when the detected current increases.

12. The method of claim 8, comprising adjusting a duty ratio of the switching signal to maintain a consistent output voltage at the output of the boost converter, wherein the duty ratio is adjusted independently of the switching frequency and the switching frequency is adjusted independent of the duty cycle.

13. The method of claim 8, wherein the boost converter is a single phase boost converter.

14. A power supply for a vehicle, the power supply comprising:
a boost converter circuitry configured to convert a voltage received at an input to a higher output voltage at an output of the boost converter circuitry;
a driver to control the boost converter circuitry by providing a switching signal to the boost converter circuitry at a specified duty cycle and switching frequency, wherein the output voltage is controlled by adjusting the duty cycle;
a current sensor to detect a current at the output of the boost converter circuitry; and
a frequency controller to adjust the switching frequency provided by the driver based on the current detected by the current sensor.

15. The power supply of claim 14, wherein the switching frequency is adjusted to maintain a consistent ripple current ratio as the current at the output of the boost converter circuitry varies.

16. The power supply of claim 15, wherein the consistent ripple current ratio is between 0.2 and 0.4 for all values of the output current above zero.

17. The power supply of claim 14, wherein the frequency controller increases the switching frequency when the output current decreases, and decreases the switching frequency when the output current increases.

18. The power supply of claim 14, wherein frequency controller is a digital frequency controller comprising an integrated circuit chip.

19. The power supply of claim 14, wherein frequency controller is an analog frequency controller comprising an antilog amplifier.

20. The power supply of claim 14, wherein the boost converter circuitry comprises a single phase boost converter.
